(19) United States
(12) Patent Application Publication
(10) Pub. No.: US 2014/0324603 A1
(43) Pub. Date: Oct. 30, 2014

(54) COMPACT DATA INTERFACE FOR REAL TIME BIDDING IN DIGITAL VIDEO ADVERTISEMENT SYSTEMS

(71) Applicant: BrightRoll, Inc., San Francisco, CA (US)

(72) Inventors: Pravin Savkar, San Francisco, CA (US); Daniel Wei-Tze Hsiung, San Francisco, CA (US); Jason Endo, San Francisco, CA (US); Giao Huu Phan, San Francisco, CA (US); Ryan Walker, San Francisco, CA (US); Aaron Stone, San Francisco, CA (US)

(73) Assignee: BRIGHTROLL, INC., San Francisco, CA (US)

(21) Appl. No.: 14/217,006

(22) Filed: Mar. 17, 2014

Related U.S. Application Data
(60) Provisional application No. 61/800,845, filed on Mar. 15, 2013.
(60) Provisional application No. 61/799,818, filed on Mar. 15, 2013.

(51) Int. Cl. G06Q 30/02

(52) U.S. Cl. CPC G06Q 30/0275
USPC 705/14.71

(57) ABSTRACT

A digital media advertisement delivery system comprising a real time bidding (RTB) platform and a plurality of bidder computers. The RTB platform is configured to receive an indication of an opportunity to display a digital media advertisement to a consumer, and generating a bid request for auctioning the opportunity to a plurality of bidders, the bid request comprising a plurality of fields including information about the opportunity. The plurality of bidder computers are configured to receive the bid request comprising a first plurality of fields including information about the opportunity, decide, based on the received information in the plurality of fields, whether or not to bid, and send a bid response, when decision is to bid, comprising a second plurality of response fields, at least some of which include information in direct response to the first plurality of fields.

### CROSS REFERENCE TO RELATED APPLICATIONS

This patent document claims the benefit of priority of U.S. Provisional Patent Application No. 61/800,845, filed on Mar. 15, 2013, entitled “COMPACT DATA INTERFACE FOR REAL TIME BIDDING” and U.S. Provisional Patent Application No. 61/799,818, filed on Mar. 15, 2013, entitled “PIPELINED DISTRIBUTED SYSTEM FOR VIDEO ADVERTISEMENTS.” The entire content of the before-mentioned patent applications is incorporated by reference herein.

### TECHNICAL FIELD

The present document generally relates to digital video advertisement delivery.

### BACKGROUND

Many companies seek to attract customers by promoting their products or services as widely as possible. Online video advertising is a form of promotion that uses the Internet and World Wide Web for delivering video advertisements to attract customers. Online advertising can be facilitated through online advertising systems or networks that connect advertisers to web sites that want to sell advertising space. One function of an advertising system or network is aggregation of advertisement space supply from publishers and matching it with advertiser demand. Advertisement exchanges are technology platforms used by online advertising systems or networks for buying and selling online advertisement impressions. Advertisement exchanges can be useful to both buyers (advertisers and agencies) and sellers (online publishers) because of the efficiencies they provide. Implementations of advertisement exchanges may be limited by the types of advertisements they can buy and sell, their inventory size, and abilities to target specific viewers (e.g., potential customers).

As the number of users or consumers accessing the Internet using video-playback capable wireless devices such as smartphones and tablet devices grows, improvements to online video advertising are useful or beneficial to users or consumers, advertisers and online publishers.

### SUMMARY

The disclosed techniques provide for a standardized way by which bidders can electronically communicate with a real-time bidding (RTB) exchange for the placement of digital media advertisements in an opportunity to display the advertisements to the customers. In particular, a bid request message is provided in which fields are included to meet business objectives of the bidders and/or the RTB exchange operator. The bid request is sent from the RTB exchange to the bidders. A bid response message is disclosed to facilitate selection of a bidder by the RTB exchange.

In one example aspect, methods, apparatus and systems for implementing a bid request generation and transmission technique include receiving an indication of an opportunity to display a digital media advertisement to a consumer or user and generating a bid request for auctioning the opportunity to a plurality of bidders, the bid request comprising a plurality of fields including information about the opportunity.

In another example aspect, methods, apparatus and systems for implementing techniques for responding to a bid request include receiving a bid request comprising a first plurality of fields including information about the opportunity, deciding, based on the received information in the plurality of fields, whether or not to bid and sending a bid response, when decision is to bid, comprising a second plurality of response fields, at least some of which include information in direct response to the first plurality of fields.

In certain embodiments, a machine-readable medium comprising machine-readable instructions for causing a processor to execute a method as described above is discussed.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is an example of a real time bidding video ad insertion system;

FIG. 2 is flowchart of an example of a process of generating a bid request;

FIG. 3 is a block diagram of an example of an apparatus for generating a bid request;

FIG. 4 is a flowchart representation of an example of a process of generating a bid response;

FIG. 5 is a block diagram representation of an example of an apparatus for responding to a bid request;

FIG. 6 depicts an example of a human readable representation of a sample bidrequest object;

FIG. 7 depicts an example of a human readable representation of a sample ‘imp’ object;

FIG. 8 is an example of a human readable representation of a sample video object for a web request;

FIG. 9 depicts an example of a human readable representation of a sample video object for a mobile request.

FIG. 10 depicts an example of a human readable representation of a sample companionad object;

FIG. 11 is an example of a human readable representation of a sample site object for a web request when the page URL is available;

FIG. 12 depicts an example of a human readable representation of a sample site object for a web request when the page URL is not available;

FIG. 13 depicts an example of a human readable representation of a sample app object for a mobile request;

FIG. 14 depicts an example of a human readable representation of a sample content object;

FIG. 15 depicts an example of a human readable representation of a sample device object for a web request;

FIG. 16 depicts an example of a human readable representation of a sample device object for a mobile request;

FIG. 17 depicts an example of a human readable representation of a sample ‘user’ object for a web request;

FIG. 18 depicts an example of a human readable representation of a sample device object for a web request;

FIG. 19 depicts an example of a human readable representation of a sample bidresponse object;

FIG. 20 depicts an example of a human readable representation of a sample seatbid object;

FIG. 21 depicts an example of a human readable representation of a sample bid object;

FIG. 22 depicts an example of a human readable representation of a sample bid object;

FIG. 23 depicts an example of a human readable representation of a Media_Desc object.

### DETAILED DESCRIPTION

In the following detailed description, numerous specific details are set forth to provide a full understanding of the present disclosure. It will be obvious, however, to one ordinarily skilled in the art that the embodiments of the present disclosure may be practiced without some of these specific details. In other instances, well-known structures and techniques have not been shown in detail so as not to obscure the disclosure.

The Internet has become an essential part of many people's lives. Users or consumers may rely on the Internet for receiving and sending information related to work, education and personal life. The web sites and infrastructure providers that make this facility available to the users often derive revenue from advertisements placed on user's viewing devices when users are accessing the Internet.

Confluence of several technologies, e.g., increased speeds of internet connectivity and efficient video compression formats has made it possible to display media advertisements (e.g., audio/video program clips) to users, in addition to the traditional static advertisements (sometimes called banners). Media ads may be provided in the form of pre-roll ads that are ad clips which are played prior to the user-requested video plays or ads that are played during or after the user's playback of requested media.

In addition to being an effective medium for communicating a message, video advertisements further offer opportunities to advertisers to measure user interest based on various measurement techniques such as how long did the user watch the ad for, did the user interact with the ad and so on.

Extending the traditional architecture of a real-time bidding exchange (RTB) platform, which finds a suitable bidder (e.g., advertiser) for an opportunity to place an advertisement (e.g., on a web page being loaded on a viewer device) to include digital media ads provides several additional operational complexities. An industry initiative, called OpenRTB, was set up to document the messages electronically exchanged between the RTB platform and a bidder.

The OpenRTB bid request message is typically transmitted by the RTB Exchange to multiple bidders. The technology disclosed in this patent document was in part based on the recognition that including several fields to the bid request message can provide a bidder with an opportunity to make complex business decisions about whether or not to bid for the request and how much money to put in the bid response and the recognition that such features may improve operational efficiency. For example, the inclusion of such messages in the bid request message can reduce the amount of traffic going back and forth between the bidders and the exchange to gather the desired information. In one advantageous aspect, the reduction in additional request/response messages alleviates network bandwidth. In another advantageous aspect, the implementation complexity on the RTB exchange side and the bidder side is reduced. In yet another aspect, latency of the time between when a bid request is generated and a bid is finally accepted by the RTB Exchange is also reduced.

In some implementations, the bid request could include information about the native application that will be used for displaying the digital media ad on viewer's device. This information can provide the bidder information about which application it is by providing an identification or a URL (uniform resource locator) to the application in Apple app store or in Android app store.

In some implementations, a rating of the media for the content may be included in the bid request (see, e.g., Section 6.18 of OpenRTB specification).

In some implementations, information about if video content was embeddable may be included in the bid request, as a measure of inventory quality.

In some implementations, content language may be included in the bid request. This information may be useful to a bidder in determining demographics of the viewer (e.g., Spanish speaking viewer) or for selecting the correct video clip to bid for.

In some implementations, all objects of the API may include extensions. In one advantageous aspect, this feature can be used to overcome the limitation that bid requests and responses extensions in OpenRTB 2.1 are all captured under specific objects. In some implementations, it would be advantageous to have all objects include extensions. Without the availability of extensions an extra processing step of re-creating the object structure for which a given field is describing attributes would have to be performed—this extra processing would cause additional delay and adversely affect the operational efficiency.

In some implementations, to aid bidders in matching their bids to inventory offered for RTB auction, a companion banner type may be included in the bid request. The Interactive Advertising Bureau's (IAB) Digital Video Ad Serving Template (VAST) standard defines several types of companions—this exposes the types supported by the inventory to the buyer. Therefore, if the buyer has a campaign that requires companion support, the buyer can take a bidding decision based on compatible companion types, or can convert the companion into a supported format.

As an example of a video advertisement exchange, the BrightRoll Exchange (BRX) from BrightRoll, Inc. offers billions of monthly video advertising impressions, reaching millions of users on thousands of web sites and mobile apps across the four screens—web, mobile, tablet and connected TVs. Certain features in the BRX for real-time bidding (RTB) of video ad inventory are mentioned or described in the context of understanding the disclosed technology.

RTB allows buyers to bid on ad inventory using their own decisioning technology on an impression by impression basis, moving buy-side ad decisioning up the delivery chain to the buyers own platform from the publisher's ad server or exchange. Buyers decide whether to bid on a particular impression, how much they want to pay and which creative they want to deliver (unlike non-RTB models that require the buyer to serve an ad when the downstream ad server determines the impression meets the buyer's need, and the buyer only has an opportunity for creative optimization). The auction platform evaluates all the bids, determines the winner and serves the winning creative.

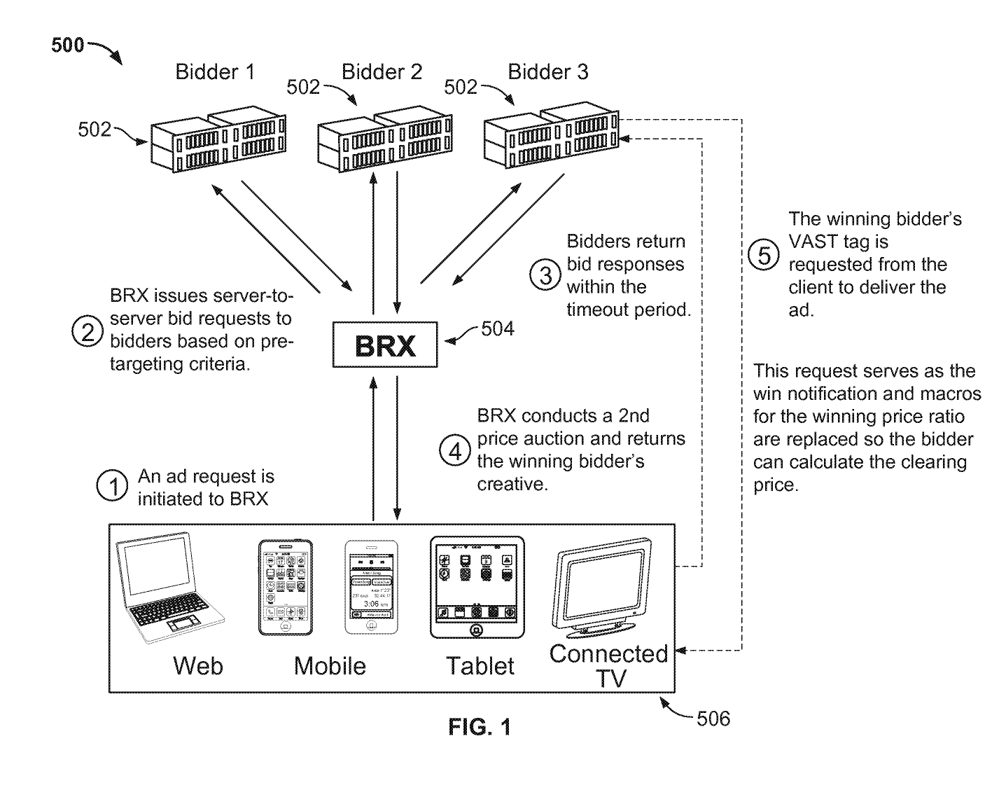

FIG. 1 depicts an example 500 of messages that may be exchanged among various entities or modules involved in bidding and placement of video advertisements. User (devices 506 encounters a video ad opportunity on a website or in an application and a BRX (504) ad request is initiated (message 1).

BRX 504 issues bid requests (messages 2) to bidders (502) that qualify for the impression opportunity based on pre-targeting settings.

Each bidder 502 makes an ad decision based on the campaigns trafficked within their systems and returns a bid response (including a max bid and the creative details) within the timeout period as defined in the bid request (default of 90 ms, message 3).

BRX 504 conducts a second-price auction, determines the winning bid, replaces a macro in the creative URL to reflect the clearing price (as a ratio of the max bid) and serves the associated creative down to the client (message 4).

The website or application requests the winning creative (thereby communicating the clearing price to the bidder) and serves the ad to the user (message 5).

Some examples of messages exchanged during the bid request/bid response messaging and the corresponding processing that may be performed at the receiving device are disclosed in the present document.

Processing Bid Request (message 2)

Some embodiments will send serialized protocol buffer bid requests for pre-targeted inventory as the binary payload of a HTTP POST request. SSL (Secure Sockets Layer) is not required since these are server-to-server calls. Furthermore, SSL is not recommended due to the additional processing overhead.

BIDREQUEST Object

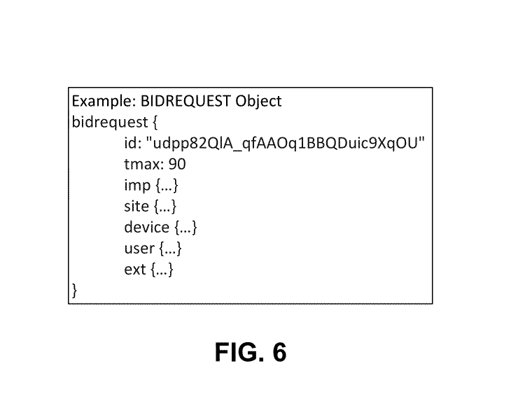

The top-level bidrequest object includes two fields, along with additional objects as described previously. FIG. 6 depicts a human readable representation of a sample bidrequest object. See Table 1 for additional description of fields.

TABLE 1

| Field | |
|---|---|
| Name | Description |
| id | The bid request ID uniquely identifies every transaction, and |
| | must be included in the bid response. |
| tmax | The default timeout for BRX RTB transactions including net- |
| | work latency is 90 ms; the timer starts when the request is |
| | made to your bidder by BRX, and ends when the response is |
| | returned. However, this is a dynamic value that may change and |
| | can vary based on the inventory. Bidders must honor the time- |
| | out for the each transaction as defined in bidrequest−>tmax. |
| imp | Describes the impression opportunity. Every bid request will |
| | include one imp object. |
| site | Describes the site properties. This is typically used for web |
| | inventory. Either a site or an app object will be included - not |
| | both. |
| app | Describes the app properties. This is typically used for mobile |
| | inventory. Either a site or an app object will be included - not |
| | both. |
| device | Describes the device that the ad impression will be delivered on. |
| user | The user object contains information known or derived about the |
| | human user of the device. |
| ext | The ext object contains custom BRX data that is not part of the |
| | Open RTB standard about the impression to support advanced |
| | decisioning. |

IMP Object

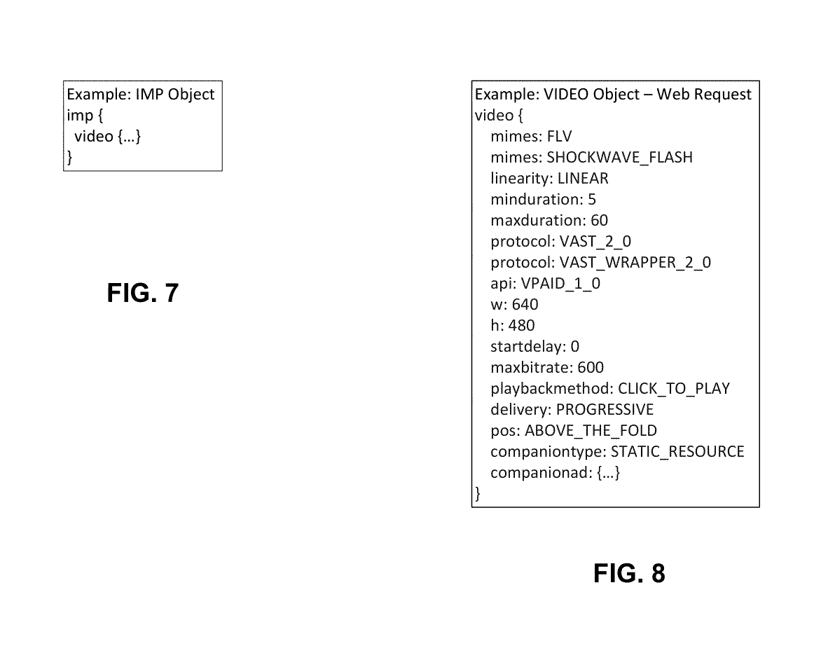

The imp object is a child of bidrequest. While Open RTB supports multiple imp objects per bid request, BRX currently only supports one. FIG. 7 depicts a human readable representation of a sample “imp” object. See Table 2 for additional description of fields.

TABLE 2

| Field | |
|---|---|
| Name | Description |
| id | Since only a single impression is offered for auction per bid |
| | request, the ID should always have a value of ‘1’. |
| video | The video object will be included to describe the video |
| | opportunity. |

VIDEO Object

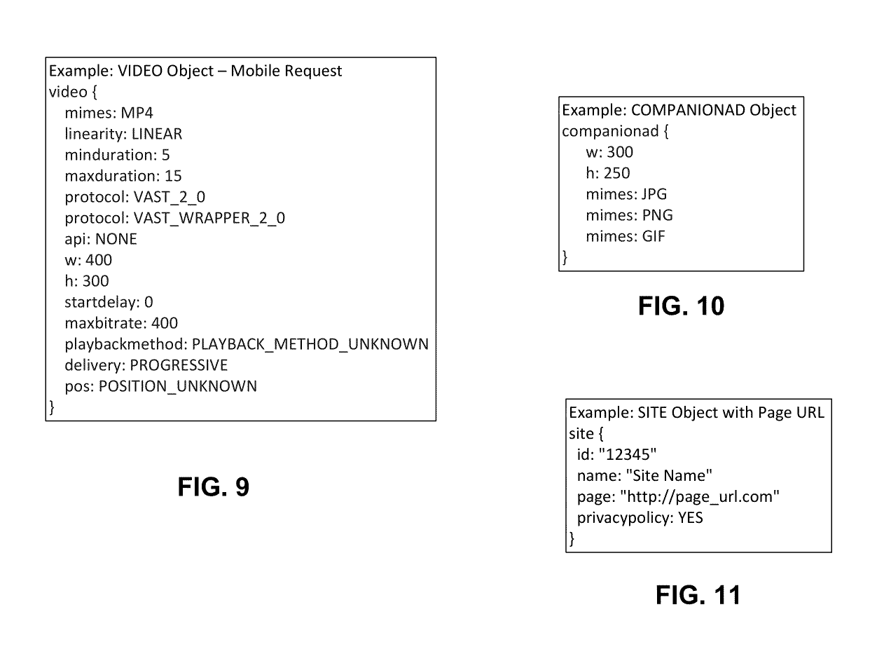

The video object is a child of the bidrequest object and describes the creative properties supported for the video impression. FIG. 8 is a human readable representation of a sample video object for a web request. FIG. 9 depicts a human readable representation of a sample video object for a mobile request. See Table 4 for additional description of fields.

TABLE 3

| Field | |
|---|---|
| Name | Description |
| mimes | Content MIME types supported for the media files. |
| | Common video MIME types include “video/x-flv” and |
| | “video/x-mp4”, while “application/x-shockwave-flash” |
| | typically applies to VPAID creatives. |
| linearity | Indicates whether the ad impression is linear or non- |
| | linear. |
| minduration | Minimum video ad duration in seconds. |
| maxduration | Maximum video ad duration in seconds. |
| protocol | Video bid response protocols supported (e.g., VAST |
| | 2.0, VAST 2.0 Wrapper). |
| api | API frameworks supported (e.g., VPAID 1.0). |
| w | Width of the player in pixels. |
| h | Height of the player in pixels. |
| startdelay | Indicates the start delay in seconds for preroll, midroll, |
| | or postroll ad placement. |
| maxbitrate | Maximum bit rate in Kbps. |
| playbackmethod | Defines whether inventory is user initiated or autoplay |
| | sound on/off. |
| delivery | List of supported delivery methods (streaming, |
| | progressive). BRX only supports progressive delivery |
| | at this time. |
| pos | Ad position on the page. |
| companiontype | Describes the VAST companion resource types sup- |
| | ported by the inventory (e.g., static resource, iframe |
| | resource, etc). |
| companionad | Optional companion ads are described by the banner |
| | object. |

COMPANIONAD Object

The companionad object is a child of the video object. Companion ads are optional—bidders may respond with an ad that does not have a companion even if the companionad object is included. Additionally, inclusion of the companionad object does not guarantee that a companion will be delivered with the impression. FIG. 10 depicts a human readable representation of a sample companionad object. See Table 4 for additional description of fields.

TABLE 4

| Field | |
|---|---|
| Name | Description |
| id | ID for the companion opportunity. |
| w | Companion width. |
| h | Companion height. |
| mimes | Content MIME types supported for the companion ad. |

SITE Object

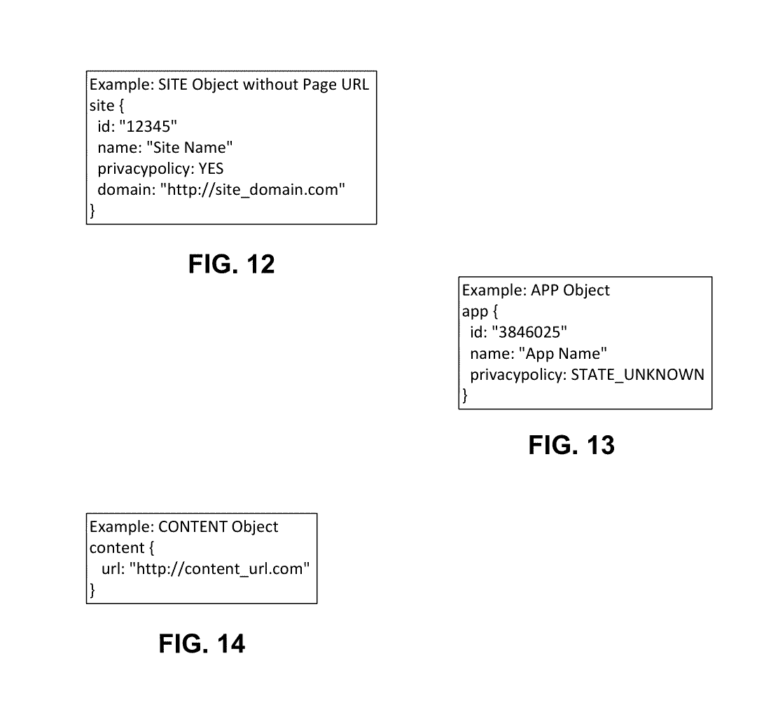

The site object is a child of the bidrequest object and describes the site properties and is typically used for web inventory. FIG. 11 is a human readable representation of a sample site object for a web request when the page URL is available. FIG. 12 depicts a human readable representation of a sample site object for a web request when the page URL is not available. See Table 5 for additional description of fields.

TABLE 5

| Field | |
|---|---|
| Name | Description |
| id | The BRX site ID. |
| name | The site name as registered with BRX. |
| page | The page URL where the ad impression will be shown. |
| | All efforts are made to ensure the value represents the |
| | URL in the address bar, but it cannot be guaranteed. |
| privacypolicy | Specifies whether the site has a privacy policy. |
| ref | Referrer URL when available |
| content | This object will provide data about the content the ad |
| | will run against when available. |
| domain | If the page URL is not available for a given impres- |
| | sion opportunity, the audited, registered domain will be |
| | provided. |

APP Object

The app object is a child of the bidrequest object and describes the application properties and is typically used for mobile inventory. FIG. 13 depicts a human readable representation of a sample app object for a mobile request. See Table 6 for additional description of fields.

TABLE 6

| Field | |
|---|---|
| Name | Description |
| id | The BRX app ID. |
| name | The app name as registered with BRX. |
| privacypolicy | Specifies whether the site has a privacy policy. |
| content | This object will provide data about the content the ad |
| | will run against when available. |

The content object is a child of the site and app objects. When content level data is available, the object is included to provide data about the content the ad will run against. FIG. 14 depicts a human readable representation of a sample content object. See Table 7 for additional description of fields.

TABLE 7

| Field | |
|---|---|
| Name | Description |
| url | The site name as registered with BRX. |

DEVICE Object

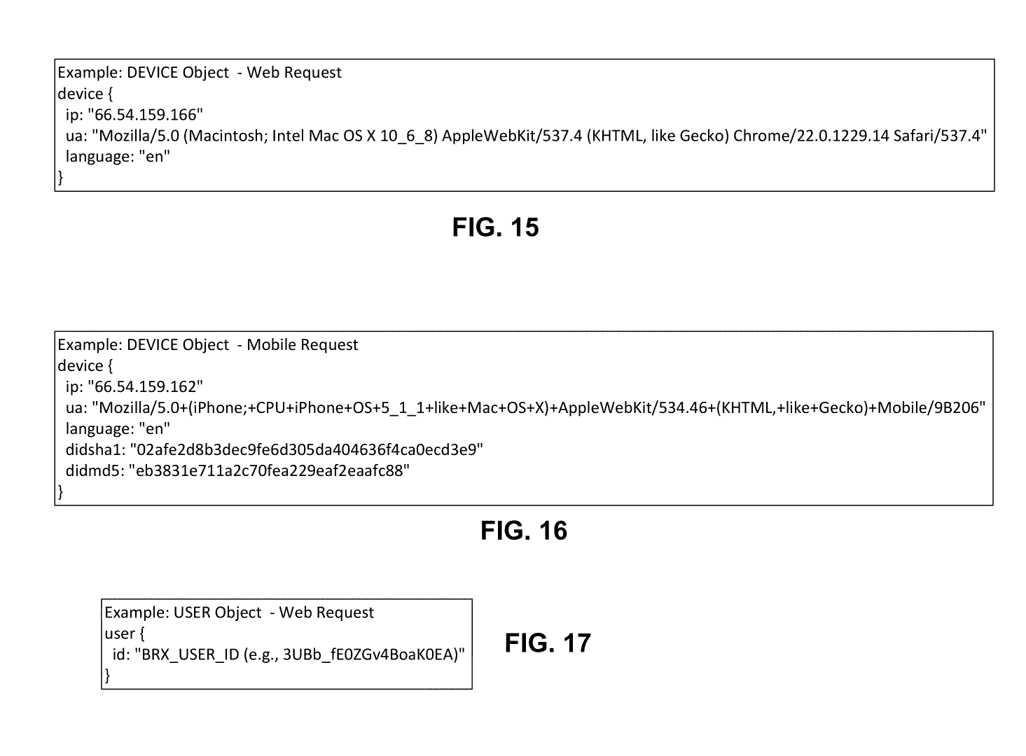

The device object is a child of the bidrequest object and describes the site properties and is typically used for web inventory. FIG. 15 depicts a human readable representation of a sample device object for a web request: FIG. 16 depicts a human readable representation of a sample device object for a mobile request (mobile requests may not include a device ID, or may include one or more of the parameters). See Table 8 for additional description of fields.

TABLE 8

| Field | |
|---|---|
| Name | Description |
| ip | IPv4 address closest to device. |
| ua | Browser user agent string. This value should be used to |
| | identify the OS, device, browser, etc. |
| language | Browser language using alpha-2/ISO 639-1 codes. |
| didsha1 | Provided for mobile devices when available in place of a user/ |
| | cookie ID. SHA1 hashed device ID; typically MAC address, |
| | Android Device ID or ODIN ID. |
| didmd5 | Provided for mobile devices when available in place of a user/ |
| | cookie ID. MD5 hashed device ID; Typically MAC address, |
| | Android Device ID or ODIN ID. |
| dpidsha1 | Provided for mobile devices when available in place of a user/ |
| | cookie ID. SHA1 hashed platform specific ID; typically UDID |
| | or Advertiser ID for iOS or Android ID. |
| dpidmd5 | Provided for mobile devices when available in place of a user/ |
| | cookie ID. MD5 hashed platform specific ID; typically UDID |
| | or Advertiser ID for iOS or Android ID. |

USER Object

The user object is a child of the bidrequest object and supplies the user ID for frequency capping and targeting purposes for web inventory. Mobile inventory includes the ID, however, it is not consistent across requests for the same user. Frequency capping and targeting should be based on the device IDs outlined in the previous section. FIG. 17 depicts a human readable representation of a sample ‘user’ object for a web request. See Table 9 for additional description of fields.

TABLE 9

| Field | |
|---|---|
| Name | Description |
| id | Unique BRX ID for the user. |

EXT Object

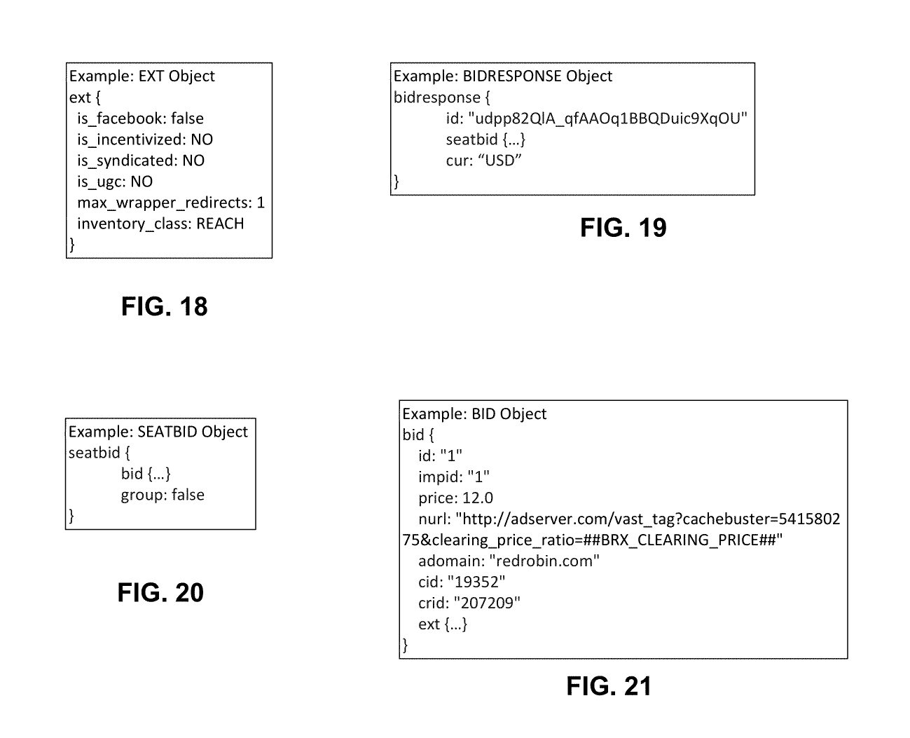

The ext object is a child of the bidrequest object and includes BRX specific data about the impression opportunity that is not part of the Open RTB standard. FIG. 18 depicts a human readable representation of a sample Ext object for a web request. See Table 10 for additional description of fields.

TABLE 10

| Field | |
|---|---|
| Name | Description |
| is_test | Flag for test bid requests; we will accept the |
| | response, but we will not serve the ad |
| is_ping | If true, respond with a no bid response |
| | (HTTP 204 “No Content”) as soon as possible |
| | without any ad decisioning |
| is_facebook | This parameter defines if the impression |
| | opportunity is on Facebook. In order to serve |
| | an ad to this inventory, you must comply with |
| | Facebook's terms and include a user feedback |
| | button. If you don't support this feature, |
| | Facebook inventory can be excluded via pre- |
| | targeting. |
| is_incentivized | This is typically gaming inventory or an offer |
| | wall where a user might get virtual currency if |
| | they watch a video ad. |
| is_syndicated | This is typically a player that can be run on |
| | multiple sites that have not been vetted by our |
| | Publisher Management team. |
| is_ugc | We categorized sites to the lowest common |
| | denominator, so if they include any user |
| | generated content they're flagged as UGC. |
| max_wrapper_redirects | The maximum number of wrapper redirects |
| | your creative may employ in order to serve |
| | successfully to this site placement. |
| inventory_class | A BRX defined indicator of inventory quality. |

Response Handling

To submit a bid, return a serialized bid response within the timeout period as defined in the bid request (including round-trip network latency).

To submit a no-bid response (“no ad”), return an empty response with a HTTP 204 “No Content” status within the timeout period (including round-trip network latency).

If bidrequest->ext->is_ping is set to true, respond with a no bid response (HTTP 204 “No Content”) as soon as possible without any ad decisioning.

Constructing a Bid Response

Once the bid request has been processed and an ad decision has been made, construct and return a bid response to participate in the auction.

BIDRESPONSE Object

The top-level bidresponse object. FIG. 19 depicts a human readable representation of a sample bidresponse object. See Table 11 for additional description of fields.

TABLE 11

| Field | Re- | |
|---|---|---|
| Name | quired? | Description |
| id | Yes | Return bidrequest−>id. |
| bidid | No | OPTIONAL: Bidders may optionally return a string |
| | | representing their internal ID for the auction. BRX |
| | | currently ignores this field. |
| seatbid | Yes | An object to describe the winning bid for a given |
| | | seat on the bidder's platform. BRX currently only |
| | | supports a single seatbid object in the bid response. |
| cur | Yes | BrightRoll only supports USD -- return a value of |
| | | “USD” |

SEATBID Object

The seatbid object is a child of the bidresponse object. FIG. 20 depicts a human readable representation of a sample seatbid object. See Table 12 for additional description of fields.

TABLE 12

| Field | Re- | |
|---|---|---|
| Name | quired? | Description |
| bid | Yes | Each bid object in the bid response should |
| | | correspond with an imp object from the bid |
| | | request |
| seat | No | ID of the bidder seat on whose behalf this bid |
| | | is made |
| group | No | This field defines if impressions must be won |
| | | or lost as a group. Since BRX only supports a |
| | | single impression auction per transaction, this |
| | | field is currently ignored. |

BID Object

The bid object is a child of the seatbid object. FIG. 21 depicts a human readable representation of a sample bid object. See Table 13 for additional description of fields.

TABLE 13

| Field | Re- | |
|---|---|---|
| Name | quired? | Description |
| id | Yes | ID for the bid object chosen by the bidder for |
| | | tracking and debugging purposes. Useful when |
| | | multiple bids are submitted for a single impres- |
| | | sion for a given seat. |
| impid | Yes | Return the value of bidrequest−>imp−>id. |
| price | Yes | Bid price in CPM. WARNING/Best Practice |
| | | Note: Although this value is a float, Open RTB |
| | | strongly suggests using integer math for |
| | | accounting to avoid rounding errors. |
| nurl | Yes | The VAST tag to serve if the bid wins the BRX |
| | | auction. A random number or cache busting string |
| | | should be added/expanded before submitting in the |
| | | bid response. #BRX_CLEARING_PRICE## |
| | | should be included in the URL to pass the winning |
| | | price ratio. |
| adomain | Yes | Advertiser's primary or top-level domain(s) for |
| | | advertiser checking. |
| cid | Yes | Campaign ID for the submitted ad |
| crid | Yes | Creative ID for the submitted ad |
| ext | Yes | Custom bid extensions required by BRX |

EXT Object

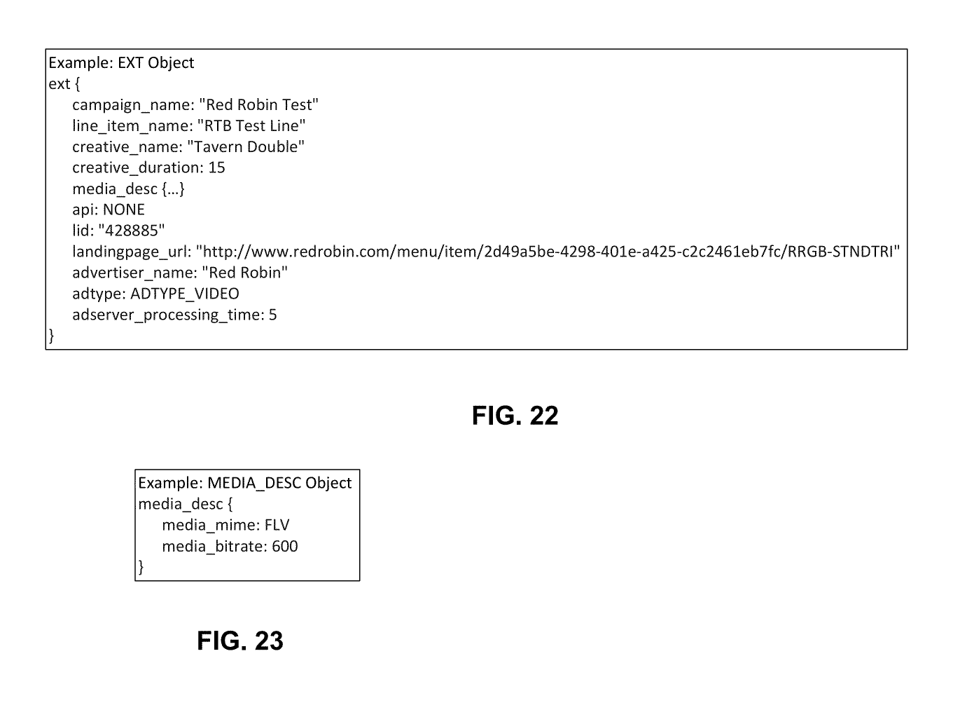

The ext object is a child of the bid object and captures custom bid extensions required by BRX. These extensions are intended to help ensure creatives are compatible with the target inventory and to aid with troubleshooting. FIG. 22 depicts a human readable representation of a sample bid object. See Table 14 for additional description of fields.

TABLE 14

| Field | Re- | |
|---|---|---|
| Name | quired? | Description |
| campaign_name | Yes | Friendly campaign name |
| line_item_name | Yes | Friendly line item name |
| creative_name | Yes | Friendly creative name |
| creative_duration | Yes | Duration of the creative returned in |
| | | seconds. |
| media_desc | Yes | Object describing the media file |
| | | returned in the VAST associated |
| | | with the nurl. Currently, BRX only |
| | | supports returning a single media |
| | | file per VAST document. |
| api | Yes | API framework required by the |
| | | returned creative (e.g., VPAID) |
| lid | Yes | Line item ID of the returned |
| | | creative |
| landingpage_url | Yes | Landing page URL for the |
| | | campaign |
| advertiser_name | Yes | Advertiser name |
| companiontype | Yes | Companion types in the returned |
| | | creative |
| adtype | Yes | Defines if the bid is for an impres- |
| | | sion opportunity defined by a video |
| | | or banner object. NOTE: BRX |
| | | only supports bids for video |
| | | objects at this time. |
| adserver_processing_time | Yes | Bidder ad server processing time in |
| | | milliseconds |

MEDIA_DESC Object

The media_desc object is a child of bidresponse->seatbid->bid->ext and describes the media file returned in the VAST associated with the nurl. Currently, BRX only supports returning a single media file per VAST document. FIG. 23 depicts a human readable representation of a sample media_desc object. See Table 15 for additional description of fields.

TABLE 15

| Field | Re- | |
|---|---|---|
| Name | quired? | Description |
| media_mime | Yes | Mime type of the media file associated |
| | | with the returned creative |
| media_bitrate | Yes | If the media file is a video, provide the |
| | | associated bitrate |

Additional Bid Request Extensions, Bid Response Extensions, example syntax for bid request and bid response messages, which can be included in a bid request as data fields, are further described. In various embodiments, the following extensions, based on a business agreement between an RTB platform provider and a bidder, may be used.

is_facebook: Boolean indicator to identify if the inventory is a Facebook (FB) inventory; there are specific creative requirements if FB is true. In general, an extension which references to a social networking website, may be used. In one advantageous aspect, this extension may provide opportunity to the RTB provider to accurately provide segmentation (demographic profile) of the consumer and correlate his ad preferences with his circle of friends.

max_wrapper_redirects: Ability to dynamically define how many VAST wrapper redirects the inventory is capable of supporting either due to technical limitations or due to publisher preferences (e.g., to limit redirects for performance reasons). In one advantageous aspect, this extension may be useful to keep the message commensurate with the resources available at the sender/receiver of the bid request/bid response.

minduration (for banner inventory): This parameter describes the minimum duration of content supported when the inventory is represented as a banner object. This is applicable to inventory that is not represented by the video component but has time dimensionality (but is not limited to video ad formats). For example, a mobile ad that is represented as a banner object and accepts video or rich media ads in return via HTML5.

maxduration (for banner inventory): This parameter describes the maximum duration of content supported when the inventory is represented as a banner object. This is applicable to inventory that is not represented by the video component but has time dimensionality (but is not limited to video ad formats). For example, a mobile ad that is represented as a banner object and accepts video or rich media ads in return via HTML5.

is_incentivized: Field to define whether inventory is incentivized in the format of Yes/No/Unknown.

is_syndicated: Field to define whether inventory is syndicated in the format of Yes/No/Unknown.

is_ugc: Field to define whether inventory is user generated content in the format of Yes/No/Unknown.

inventory_class: Field to define a custom categorization of inventory.

Custom Bid Response Extensions:

Additional detail about the bid in the BRX spec that are above and beyond the core Open RTB spec. These fields are submitted by bidders when bidding on BRX inventory programmatically.

VIDEO/MOBILE/RICH MEDIA EXTENSIONS—These innovations protects the exchange, the publisher, and increases the odds that an impression event will occur by ensuring that a compatible ad is delivered to the inventory (e.g., a bidder without a compatible ad would not win, or this info could allow BRX to convert an otherwise incompatible ad into a compatible format if possible).

creative_duration: Describes the length of the creative being returned. While the min/max values are provided in the bid request to the bidder per Open RTB, this field provides the ability for BRX to run a validation check to ensure the bidder is decisioning correctly. This protects the exchange, the publisher, and increases the odds that an impression event will occur by ensuring that a compatible ad is delivered to the inventory.

api: Bidder supplied declaration of the API framework(s) supported by the creative returned. While the supported API frameworks are provided in the bid request to the bidder per Open RTB, this field provides the ability for BRX to run a validation check to ensure the bidder is decisioning correctly. This protects the exchange, the publisher, and increases the odds that an impression event will occur by ensuring that a compatible ad is delivered to the inventory.

media_desc (Media Description Object): Object describing the one or more media file(s) included in the bid (some creatives support multiple media files). While the compatible attributes are provided in the bid request to the bidder per Open RTB, this field provides the ability for BRX to run a validation check to ensure the bidder is decisioning correctly. This protects the exchange, the publisher, and increases the odds that an impression event will occur by ensuring that a compatible ad is delivered to the inventory. Currently, this object includes the mime type of the file and the bitrate, but other fields (including creative duration and api which are in the custom extension but not in this object—this would better address the case for multiple media files) may be included in the future.

adtype: Currently, Open RTB supports Banner and Video inventory/ad types. Each impression opportunity may be represented as one or both of those types. E.g., an impression may be represented as just Video, just Banner, or both Video and Banner opportunities. However, the creative the bidder delivers can only match one of those ad types—it must be either a creative that conforms to the video object or the banner object—it cannot be both. This field in the BRX extensions requires the bidder to declare which inventory/ad type they are responding to so that it can be handled appropriately. This protects the exchange, the publisher, and increases the odds that an impression event will occur by ensuring that a compatible ad is delivered to the inventory.

GENERAL EXTENSIONS—Assumes a hierarchy of advertiser->campaign->line item->creative (from least to most granular), however, if bidders classifications are different they can fit them into our definition.

landingpage_url: The standard Open RTB bid response includes a field to capture the advertiser domain. This extension allows the bidder to pass the actual landing page URL—i.e., when the user clicks on the ad, what is the URL they will ultimately land on. This is important because many marketing campaigns utilize “micro sites” that do not include the brand name in the URL. E.g., a brand abc with a corporate website brandabc.com might use another website “123.com” for the purpose of its marketing campaign and may then want customers to land to a web page in the 123.com domain. The website may for example be tied to the specific product that is being advertised by the conglomerate in this ad campaign.

campaign_name: Human readable—to provide visibility into what's running on our inventory and for troubleshooting purposes.

line_item_name: Human readable—to provide visibility into what's running on our inventory and for troubleshooting purposes.

line_item_id: ID for line item.

creative_name: Human readable—to provide visibility into what's running on our inventory and for troubleshooting purposes.

advertiser name: Human readable—to provide visibility into what's running on our inventory and for troubleshooting purposes.

The above disclosed extensions and the corresponding messages (bid request, bid response) may be communicated in a compact format such as protobuf format. The compact format is beneficial over traditional object message syntax such as JavaScript Object Notation (JSON) because it offers several benefits such as reducing bandwidth need, reducing chances of errors due to IP packet drops by compactizing the message to fit within a single IP packet, reducing protocol stack complexity by the message requester and receiver not having to process the data through the JavaScript protocol stack, and so on.

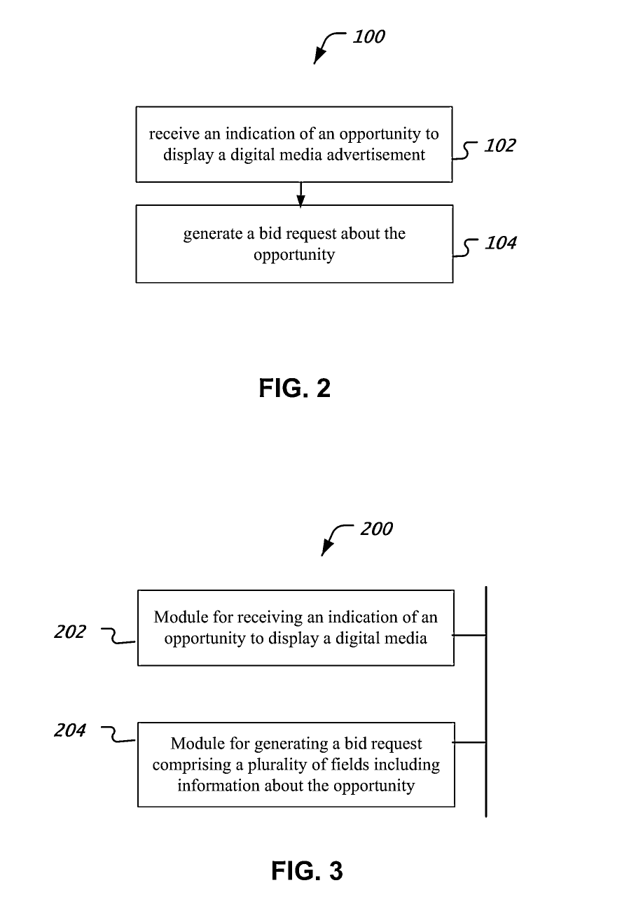

FIG. 2 is a flowchart description of a process 100 of transmitting a bid request from an RTB exchange to one or more bidders.

At 102, an indication of an opportunity to display a digital media advertisement to a consumer or user is received. The indication of the opportunity may be in the form of an ad request directly from a consumer or from a publisher or an ad server.

At 104, a bid request is generated for auctioning the opportunity to a plurality of bidders, the bid request comprising a plurality of fields including information about the opportunity.

In various implementations, the bid request may include one or more fields, as previously discussed.

In some implementations, the bid request comprises a plurality of information objects, each information object having its own extension field in which attributes of the information objects are included.

FIG. 3 is a block diagram representation of an apparatus 200 for facilitating delivery of a media advertisement to a consumer. The module 202 is for receiving an indication of an opportunity to display a digital media advertisement to a consumer. The module 204 is for generating a bid request for auctioning the opportunity to a plurality of bidders, the bid request comprising a plurality of fields including information about the opportunity.

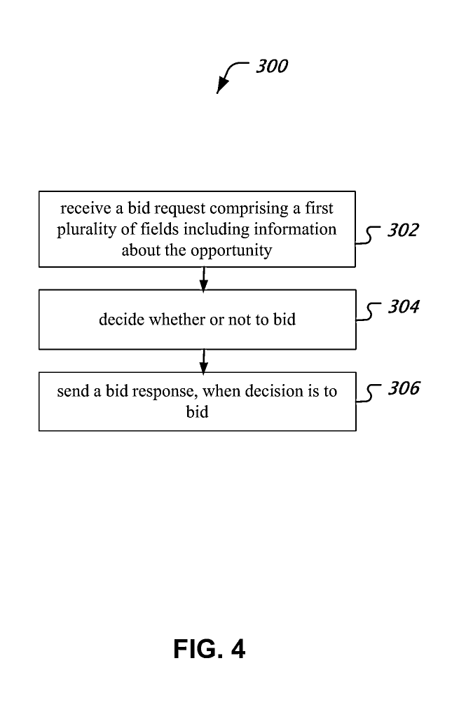

FIG. 4 is a flowchart representation of a process 300 bidding for an opportunity to deliver a media advertisement to a user. The process 300 may be implemented, e.g., at a bidder's computer.

At 302, a bid request comprising a first plurality of fields including information about the opportunity is received.

At 304, based on the received information in the plurality of fields, a decision is made about whether or not to bid.

At 306, a bid response it sent, when decision is to bid, comprising a second plurality of response fields, at least some of which include information in direct response to the first plurality of fields.

The first plurality of fields may include one of the several fields discussed in this document. In the response, the bidder may incorporate at least one indication, e.g., program language, content rating, etc.

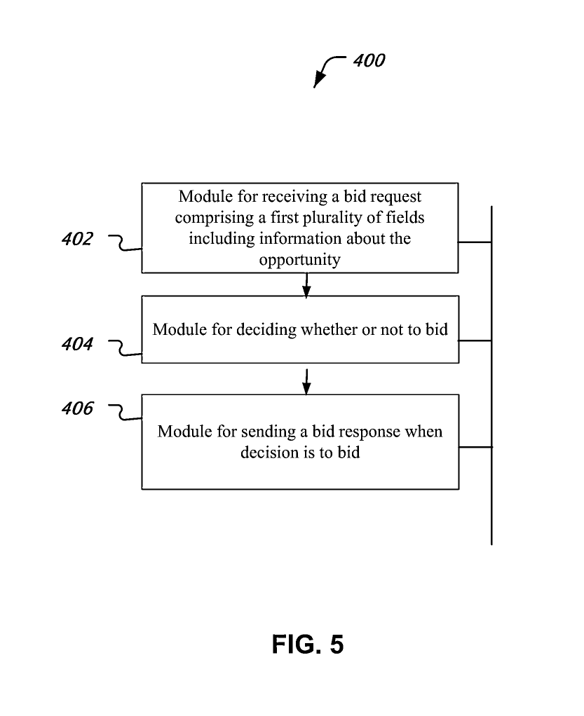

FIG. 5 is a block diagram of an apparatus 400 for responding to a bid request for delivery of media advertisement. The module 402 is for receiving a bid request comprising a first plurality of fields including information about the opportunity. The module 404 is for deciding, based on the received information in the plurality of fields, whether or not to bid. The module 406 is for sending a bid response, when decision is to bid, comprising a second plurality of response fields, at least some of which include information in direct response to the first plurality of fields.

In some implementations, a compact, binary data format such as protobuf format, can be used for transmitting and storing bid request and bid response, and other communication, in the ad delivery system. In some implementations, the trafficker can pre-compute bid requests with data to save computational resources so that only run-time data is to be included during actual use.

In some implementations, the message content (e.g., the binary protobuf data) is stored in memory in their serialized format so to avoid having to perform a deep copy of the data for every request. Instead just a copy and deserialization each time a bid is requested is performed. Because of the levels of objects involved, a bid request or a bid response can in general have multiple iterative layers of syntax, making it a difficult task to copy and store this information in the nested object form.

Binary data formats such as protobuf are a binary format so it is hard to debug. In some implementations, it may be advantageous to use tools that allow to take the binary data and output it in a human readable output (e.g., json).

One of skill in the art will appreciate that techniques for enriching bid request and bid response in a video ad delivery system are disclosed. The overarching requirement for video ad insertion is the response time within which a consumer receives the video ad. The disclosed techniques of storing data in a deserialized format, using a compact format for data transfer and storage and including several pieces of information up-front in bid request messages significantly reduce system complexity and reduce latency through the system.

The disclosed and other embodiments and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A computer-implemented method of facilitating presentation of a digital media advertisement (ad), the method comprising:
receiving an indication of an opportunity to display a digital media advertisement to a consumer device of a consumer; and
generating a bid request for auctioning the opportunity to a plurality of bidders, the bid request comprising a plurality of fields including information about the opportunity.

2. The method of claim 1, wherein a field of the plurality of fields identifies a native application on the consumer device, the native application being used for displaying the digital media advertisement to the consumer.

3. The method of claim 1, wherein a field of the plurality of fields identifies a media rating that is to be met by a winning bid.

4. The method of claim 1, wherein a field of the plurality of fields identifies whether or not the digital media advertisement is embeddable.

5. The method of claim 1, wherein a field of the plurality of fields identifies a language associated with the digital media advertisement.

6. The method of claim 1, further comprising:
storing the bid request using a compact and serialized data format.

7. An apparatus for facilitating delivery of a digital media advertisement (ad), comprising:
a receiver module that receives an indication of an opportunity to display a digital media advertisement to a consumer device of a consumer;
a bid request generator module that generates a bid request for auctioning the opportunity to a plurality of bidders, the bid request comprising a plurality of fields including information about the opportunity.

8. The apparatus of claim 7, wherein a field of the plurality of fields identifies a native application on the consumer device, the native application being used for displaying the digital media advertisement to the consumer.

9. The apparatus of claim 7, wherein a field of the plurality of fields identifies a media rating that is to be met by a winning bid.

10. The apparatus of claim 7, wherein a field of the plurality of fields identifies whether or not the digital media advertisement is embeddable.

11. The apparatus of claim 7, wherein a field of the plurality of fields identifies a desired language associated with the digital media advertisement.

12. A computer program product comprising a computer readable medium having code stored thereon, the cod, when executed, causing a processor to implement a method of facilitating presentation of a digital media advertisement (ad), the method comprising:
receiving an indication of an opportunity to display a digital media advertisement to a consumer device of a consumer;
generating a bid request for auctioning the opportunity to a plurality of bidders, the bid request comprising a plurality of fields including information about the opportunity.

13. The computer program product of claim 12, wherein a field of the plurality of fields identifies a native application on the consumer device, the native application being used for displaying the digital media advertisement to the consumer.

14. The computer program product of claim 12, wherein a field of the plurality of fields identifies a media rating that is to be met by a winning bid.

15. The computer program product of claim 12, wherein a field of the plurality of fields identifies whether or not the digital media advertisement is embeddable.

16. The computer program product of claim 12, wherein a field of the plurality of fields identifies a desired language associated with the digital media advertisement.

17. A computer-implemented method of bidding for an opportunity to deliver a media advertisement to a consumer device of a consumer, the method comprising:
receiving a bid request comprising a first plurality of fields including information about the opportunity;
deciding, based on the received information in the plurality of fields, whether or not to bid, and
sending a bid response, when decision is to bid, comprising a second plurality of response fields, at least some of which include information in direct response to the first plurality of fields.

18. The method of claim 17, wherein a field of the first plurality of fields identifies a native application on the consumer device, the native application being used for displaying the digital media advertisement to the consumer.

19. The method of claim 17, wherein a field of the first plurality of fields identifies a media rating that is to be met by a winning bid.

20. The method of claim 17, wherein a field of the first plurality of fields identifies whether or not the digital media advertisement is embeddable.

21. The method of claim 17, wherein a field of the first plurality of fields identifies a desired language associated with the digital media advertisement.

22. The method of claim 17, wherein the bid response is stored using a compact, serialized data format.

23. An apparatus for bidding for an opportunity to deliver a media advertisement to a consumer device of a consumer, the apparatus comprising:
a receiver module that receives a bid request comprising a first plurality of fields including information about the opportunity;
a decision module that decides, based on the received information in the plurality of fields, whether or not to bid, and
a sender module that sends a bid response, when decision is to bid, comprising a second plurality of response fields, at least some of which include information in direct response to the first plurality of fields.

24. The apparatus of claim 23, wherein a field of the first plurality of fields identifies a native application on the consumer device, the native application being used for displaying the digital media advertisement to the consumer.

25. The apparatus of claim 23, wherein a field of the first plurality of fields identifies a media rating that is to be met by a winning bid.

26. The apparatus of claim 23, wherein a field of the first plurality of fields identifies whether or not the digital media advertisement is embeddable.

27. The apparatus of claim 23, wherein a field of the first plurality of fields identifies a desired language associated with the digital media advertisement.

28. A computer program product comprising a computer-readable medium having code stored thereon, the code, when executed, causing a processor to implement a method of bidding for an opportunity to deliver a media advertisement to a consumer device of a consumer, the method comprising:
receiving a bid request comprising a first plurality of fields including information about the opportunity;
deciding, based on the received information in the plurality of fields, whether or not to bid, and
sending a bid response, when decision is to bid, comprising a second plurality of response fields, at least some of which include information in direct response to the first plurality of fields.

29. The computer program product of claim 28, wherein a field of the first plurality of fields identifies a native application on the consumer device, the native application being used for displaying the digital media advertisement to the consumer.

30. The computer program product of claim 28, wherein a field of the first plurality of fields identifies a media rating that is to be met by a winning bid.

31. The computer program product of claim 28, wherein a field of the first plurality of fields identifies whether or not the digital media advertisement is embeddable.

32. The computer program product of claim 28, wherein a field of the first plurality of fields identifies a desired language associated with the digital media advertisement.

33. A digital media advertisement delivery system comprising a real time bidding (RTB) platform and a plurality of bidder computers, wherein
the RTB platform is configured to:
receive an indication of an opportunity to display a digital media advertisement to a consumer device of a consumer; and
generating a bid request for auctioning the opportunity to a plurality of bidders, the bid request comprising a plurality of fields including information about the opportunity; and
the plurality of bidder computers are configured to:
receive the bid request comprising a first plurality of fields including information about the opportunity;
decide, based on the received information in the plurality of fields, whether or not to bid, and
send a bid response, when decision is to bid, comprising a second plurality of response fields, at least some of which include information in direct response to the first plurality of fields.
